(19) United States
(12) Patent Application Publication
(10) Pub. No.: US 2026/0104037 A1
(43) Pub. Date: Apr. 16, 2026

(54) IMPROVEMENTS RELATING TO WIND TURBINE BLADE ANTI-ICING SYSTEMS

(71) Applicant: VESTAS WIND SYSTEMS A/S, Aarhus N (DK)

(72) Inventors: Julian ANAYA CALVO, Valladolid (ES); Mohamed Hashim ARIYUR, Newport (GB); Jesper HØRUP, Faarup (DK)

(21) Appl. No.: 19/116,747

(22) PCT Filed: Sep. 18, 2023
(86) PCT No.: PCT/DK2023/050223

§ 371 Date: Mar. 28, 2025

(30) Foreign Application Priority Data
Sep. 30, 2022 (DK) PA202270478
Oct. 3, 2022 (DK) PA202270480

(51) Int. Cl. F03D 80/40; F03D 80/30

(52) U.S. Cl. CPC F03D 80/401; F03D 80/301

(57) ABSTRACT

A wind turbine blade comprising an anti-icing system (30) comprising an electrothermal heating arrangement (35) configured to provide heat to an external surface of the blade, wherein the electrothermal heating arrangement is connected to a power supply interface (38) of the wind turbine blade by way of a power supply conductor (40) and an earth conductor (44). The blade further comprises a lightning protection system (31) having a lightning strike protection device (56) associated with an electrothermal heating element of the heating arrangement, the lightning strike protection device being connected to a lightning down conductor (50) of the lightning protection system leading to a current transfer unit (54) configured to transfer lightning current to a rotor hub, in use. A transient current limiting device (60) is connected in a conductive path (62) between the lightning down conductor of the lightning protection system and the earth conductor of the anti-icing system, thereby permitting induced parasitic currents in the lightning down conductor to earth through the anti-icing system. This provides the benefit of preventing electromagnetic emissions that can, otherwise, cause interference with electronics in the vicinity of the wind turbine. Thus, allowing the wind turbine to comply with established EMC standards.

### TECHNICAL FIELD

The invention relates to a wind turbine blade having an anti-icing system and a lightning protection system which mitigates against lightning strikes more effectively. The invention also resides in a wind turbine incorporating such a wind turbine blade.

### BACKGROUND

The rate of wind turbine installations is growing globally, with the result that they are required to operate in a wide range of environmental conditions. Cold climates can pose particular challenges for wind turbine operation, as sub-zero temperatures combined with significant liquid water content in the air can cause ice accumulation on wind turbine blades. Blade icing increases the mass of the blade but also reduces aerodynamic efficiency which means that the rotor generates less torque for a given wind speed, thereby affecting power generation. A further problem is that an accumulation of ice can be shed from the blade which can cause damage to other equipment in the vicinity of the wind turbine.

Various approaches are known to remove ice from wind turbine blades or to stop it forming in the first place. For example, it is known to blow hot air into the internal cavity of wind turbine blades to increase the blade surface temperature, thereby guarding against ice accretion. However, such heating systems generally have a high-power consumption and in some cases may require that a wind turbine is stationary during operation, limiting their effectiveness.

Another known approach is to incorporate one or more electrothermal heating elements below the surface of a wind turbine blade. WO2017/108064 demonstrates an example of such a system. When supplied with electrical power, the heating elements generate thermal energy which is dissipated directly into the blade surface which, generally, is a more efficient way of preventing ice accretion. One challenge with this approach is that such electrothermal heating elements increase the risk of being damaged by lightning attachments during lightning strikes. Therefore, electrothermal heating elements may be shielded by metallic panels in the wind turbine blade, which are connected into a lightning protection system on-board the blade. The proximity between the electrothermal heating elements and the shielding panels can however cause capacitive interaction, which is undesirable. It is against this background that the invention has been developed.

### SUMMARY

In one aspect of the claimed invention, there is provided a wind turbine blade comprising an anti-icing system comprising an electrothermal heating arrangement configured to provide heat to an external surface of the blade, wherein the electrothermal heating arrangement is connected to a power supply interface of the wind turbine blade by way of a power supply conductor and an earth conductor, a lightning protection system having a lightning strike protection device associated with an electrothermal heating element of the heating arrangement, the lightning strike protection device being connected to a lightning down conductor of the lightning protection system leading to a current transfer unit configured to transfer lightning current to a rotor hub, in use, and a transient current limiting device connected in a conductive path between the lightning down conductor of the lightning protection system and the earth conductor of the anti-icing system, thereby permitting induced parasitic currents in the lightning down conductor to earth through the anti-icing system.

This provides the benefit of preventing electromagnetic emissions that can, otherwise, cause interference with electronics in the vicinity of the wind turbine. Thus, allowing the wind turbine to comply with established EMC standards.

By the connection of lightning strike protection device to the lightning down conductor it may be understood that the connection is in the form of an electrical connection enabling conduction of lightning current from the protection device to the lightning down conductor.

In one embodiment of the claimed invention, the lightning strike protection device may be spaced from the electrothermal heating element so as to form a capacitive coupling.

This provides a level of protection to the electrothermal heating elements and prevents the heating elements from damage due to the high currents that result from lightning strikes.

In another embodiment, transient current limiting device may have a relatively low impedance value at a first electrical frequency range associated with the anti-icing system, and a relatively high impedance value at a second electrical frequency range associated with a lightning strike. As an example, the first electrical frequency range may be less than 100 Hz, and the second electrical frequency may be greater than 10kHz. In some embodiments, the ratio between the relative low impedance value and the relatively high impedance value may be at least 1:100.

This provides the advantage of controlling the level of current being transferred to the anti-icing system and, therefore, protects the anti-icing system from overwhelmingly high currents that would occur at higher frequencies, such as lightning.

In another embodiment, the transient current limiting device may include a resistive fuse element in the conductive path.

Beneficially, this is cost effective to implement since it is elegantly simple in terms of electronic components.

In another embodiment, the transient current limiting device may include a switch device in the conductive path. The switch device may be operable into a closed position when the anti-icing system is in operation. Optionally, and as a further example, the switch device may be operable into an open position when a lightning condition is detected and/or anticipated.

In some embodiments, the transient current limiting device may include an inductor in the conductive path. In other embodiments, the inductor may be on the high voltage side of the switch device. Thus, the transient current limiting device may be configured to include an inductor and/or a resistive fuse element.

Advantageously, therefore, the conductive path is only brought into operation when the anti-icing system may generate parasitic currents in the down conductor. In addition, a wind power plant comprising several such wind turbines of the present invention could, for example, provide detection functionality. If a lightning strike is detected, then the protective switch may be opened to protect itself and the inductor which may be degraded during a lightning strike.

In further embodiments, the transient current limiting device may include a surge protection device in parallel with the switch device.

This provides a further conduction path through which current may travel from the anti-icing system to the down conductor of the lightning protection system in the event of a lightning strike on components of the anti-icing system, and, therefore, provides a safety function.

In another aspect, the invention extends to a wind turbine incorporating a wind turbine blade as described above.

### BRIEF DESCRIPTION OF THE DRAWINGS

Examples of the invention will now be described with reference to the accompanying drawings, in which:

FIG. 1 schematically illustrates a wind turbine in accordance with an aspect of the invention, the wind turbine including a rotor and a plurality of pitchable rotor blades;

FIG. 2 shows the components of an anti-icing system and a lightning protection system that is integrated into the blades of the wind turbine;

FIGS. 3a-c illustrate the various configurations of the transient current limiting device connected in a conductive path between the lightning down conductor of the lightning protection system and the earth conductor of the anti-icing system of FIG. 2.

### DETAILED DESCRIPTION

A specific embodiment of the invention will now be described in which numerous features will be discussed in detail in order to provide a thorough understanding of the inventive concept as defined in the claims. However, it will be apparent to the skilled person that the invention may be put in to effect without the specific details and that in some instances, well-known methods, techniques, and structures have not been described in detail in order not to obscure the invention unnecessarily.

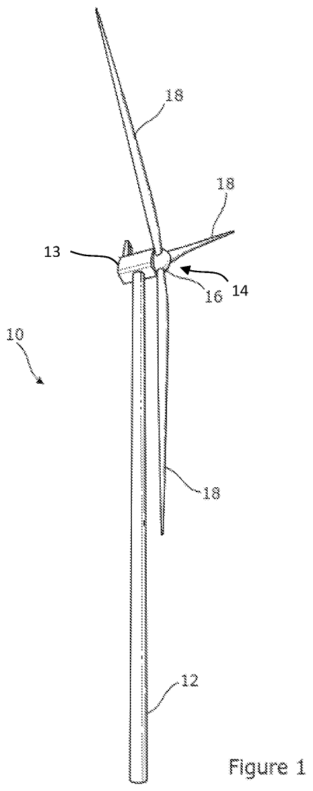

With reference to FIG. 1, a wind turbine 10 includes a tower 12 the top of which supports a nacelle 13. The nacelle comprises generation equipment (not shown) inside it to which is connected a rotor 14. The rotor 14 includes a central hub 16 and a plurality of blades 18 that extend radially from the hub 16. In the example illustrated, the wind turbine 10 is a horizontal axis wind turbine (HAWT) having three blades 18. However, the precise architecture of the wind turbine 10 is not material to the invention and the invention may be used with other wind turbine configurations. The blades 18 are connected to the hub 16 using pitch bearings such that each blade 18 may be rotated around its longitudinal axis to adjust the pitch of the blade 18.

In order for the wind turbine to operate acceptably in a variety of weather conditions, it may be equipped with various functional systems. Two of such functional systems that are typical in wind turbines 10 are blade-based anti-icing systems and lightning protection systems. Usually, such systems are functionally separate. However, some electrical interaction can occur between these two systems which is generally undesirable, as discussed above.

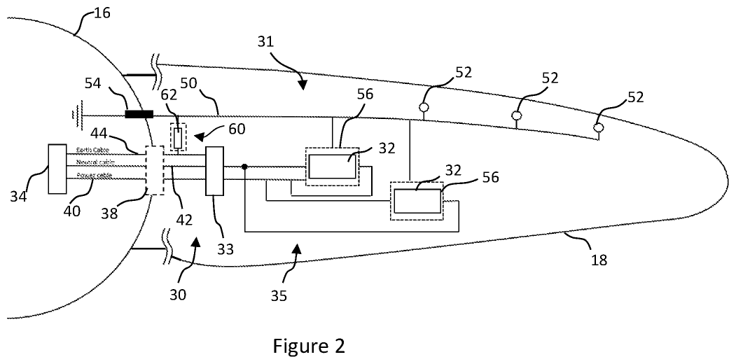

With reference now to FIG. 2, the following discussion will focus on components of an anti-icing system 30 that is integrated into the blades 18 of the wind turbine 10, and also on components of a lightning protection system 31. FIG. 2 shows both systems 30,31 in schematic form in relation to the associated wind turbine blade 18 and its hub 16.

The anti-icing system 30 comprises a plurality of electrical heating devices or elements 32 that are electrically connected to a control system 34 which provides control signals and power to the heating devices 32 by way of a power controller 33. The power controller 33 may be arranged in the blade (as shown in FIG. 2) or for example in the nacelle or another place in the wind turbine 10. Arranging the controller 33 away from the blades has the advantage that only one power controller 33 may be used to control the power in all of the blades 18 thereby reducing cost. In the illustrated embodiment, the heating devices 32 are in the form of electro-thermal heating elements. Collectively, the heating devices 32 and the power controller 33 may be referred to as a blade heating arrangement 35. The anti-icing system 30 therefore provides a means to combat the build-up of ice on the surface of the blade 18. To this end the anti-icing system 30 may be operable to apply heat to the blade surface under various triggering conditions using the one or more heating devices 32.

The heating devices 32 may be in the form of electrically conductive mats, panels or pads, which are generally known in the art. A type of suitable electrical heating device is known from WO2017/108064, which discloses heating devices in the form of a glass fibre mat coated with electrically conductive carbon. Although electrically conductive, the heating devices 32 have associated resistance values. As such, when a voltage is applied across the heating device 32, current will flow due to the resistance of the carbon material, in accordance with Ohms Law. This causes Joule heating (also known as Ohmic heating) of the heating device, which is why they are referred to as “electro-thermal” heating devices/elements. In accordance with Joule's first law shown in equation (1), the power generated by the heating devices 32 is linearly proportional to the product of its resistance/impedance (R) value and the square of an applied current, where the resistance/impedance (R) value of the materials (i.e. the glass fibre and the carbon) are typically known constants.

In the illustrated embodiment, two heating devices 32 are provided in spaced apart locations along the blade 18. As shown in FIG. 2 the spacing of the heating devices 32 is for convenience only and does not indicate a particular spacing within the blade 18. Typically, more than two heating devices 32 may be provided, although this is not essential, and the heating devices 32 may have an optimised spacing that is different to what is shown here. For example, between ten and forty heating devices 32 may be incorporated in the blade 18, distributed between windward and leeward surfaces. Certain arrangements of heating devices 32 may be devised in which less critical or vulnerable areas of the blade 18 are not provided with heating devices 32, for example regions near to the blade root. However, it should be noted at this point that the positioning and spacing of the heating devices 32 is not central to the invention and the previous arrangements are only provided by way of example. Accordingly, a single heating device 32 extending over a significant area of the blade 18 would also be an acceptable configuration.

Remaining with the schematic system view of FIG. 2, the control system 34 for the heating devices 32 is coupled to the heating devices 32 by way of a power transfer arrangement 38 and the power controller 33. The power controller 33 may be arranged after the transfer arrangement 38 (as shown in FIG. 2) or before the transfer arrangement 38.

It should be appreciated at this point that the anti-icing system 30 is only shown here for one of the blades 18 and that, in practice, each blade 18 would be provided with an identical or similar arrangement. For the sake of clarity, however, reference will be made in this discussion to a single anti-icing system 30 and it will be understood as encompassing equivalent components and functionality provided in the other blades 18 of the wind turbines 10. The various electrical and electronic components referred to above are coupled together as appropriate by suitable power and control cables and/or busbars so that power and control signals may be transferred between the respective components as required.

The power transfer arrangement 38 is a rotating interface between the pitchable blade 18 and the hub 16. Such a component is conventional and so a full discussion is not required here. However, such a component typically takes the form of a slip ring arrangement which is able to transfer power from a nacelle—or hub—based power input and provide a power output into the structure of the blade 18 for supplying power to the heating devices 32. The power transfer arrangement 38 may transfer DC and/or AC power. Typically, AC power will be transferred either as a single phase or as three phases. The control system 34 via the power transfer arrangement 38 and the power controller 33 provides a positive line 40, a neutral line 42, and an earth line 44. The positive line 40 and the neutral line 42 are connected to both the heating devices 32 for providing an appropriate power input. The earth line 44 provides a suitable earthing point for stray currents. The electrothermal heating arrangement 35 may be connected to the power supply interface 38 of the wind turbine blade by way of a power supply conductor 40, the neutral conductor 42 and the earth conductor 44.

The control system 34 is configured to control the power to the heating devices 32 appropriate to the weather conditions. The precise nature of the control methodology is not material to the inventive concept. However, it may be noted that as a minimum the control system 34 may be configured to energise the anti-icing system 30 when it detects that icing conditions are present. This determination may for example be based on sensing the ambient temperature conditions and the airborne liquid water content in the air, a combination of both factors being a reliable indicator on the likelihood of ice formation on the blades 18.

Remaining with FIG. 2, there is also shown the primary components of the lightning protection system 31 for the wind turbine blade 18. At this point it should be noted that in general lightning protection systems for wind turbine blades are known technology, as exemplified in EP2282957B1, EP2770197A1 and EP3058222B1, by way of example only.

In overview, the lightning protection system 31 comprises a conductive cable, referred to as a down conductor 50, which extends generally in a spanwise direction of the blade 18. The function of the down conductor 50 is to provide a connection between a plurality of lightning receptor points 52 or ‘receptors’ that penetrate the surface of the blade 18. Several receptors 52 are shown in FIG. 2. The receptors 52 may take various forms depending on the required configuration of the lightning protection system 31. For example, they may take the form of metal bolts having bolt heads that sit flush with the blade surface. Another form of lightning receptor 52 is a metal blade tip that is mounted that the outmost extremity of the rotor blade 18. A further example is a metallic mesh that is embedded in the surface of the blade 18. Other receptor configurations are possible, and there may be one or more receptors 52, although several receptors 52 are usual.

The down conductor 50 extends to the root of the blade 18 and terminates in a lightning current transfer unit 54, or LCTU. In general, technology relating to LCTUs is known, and is disclosed for example in WO2013182202A1 and WO2015051800A1, and typically involves a spark gap or a brush connection.

The lightning protection system 31 also includes a second type of receptor 52 which is a protective or shield device in the form of a panel 56, such as a metal mesh or sheet. There are two protective panels 56 in the illustrated examples which cover over each respective heating device 32. The protective panels 56 therefore provide a conductive shield for the heating devices 32 against the risk of lightning strikes. Lightning is therefore more likely to attach to the protective panels 56 rather than to the underlying heating devices 32. Thus, protective panels are located closer to the exterior blade surface than the heating devices 32 The protective panels may be configured to cover the heating devices, e.g. the protective panels have dimensions, span-and chord wise, and are located so that the extension in the chord and spanwise direction are greater that the corresponding extension of the heating devices.

The protective panels 56 may be any suitable configuration to achieve the shielding function. However, it is envisaged that a metallic mesh would be particularly suited to the required functionality. An example of a suitable lightning protection mesh may be appreciated in EP22820571A1 and WO2022057990A1

It will be appreciated at this point that the proximity of the protective panels 56 to the heating devices 32 creates a capacitive effect. Therefore, when the anti-icing system 30 is operational, the alternating voltage that drives heating of the heating devices 32 will induce parasitic current in the protective panels 56 which will result in current flow through the down conductor 50 to the LCTU 54. The sliding/moving connection at the LCTU 54 between the blade 18 and the hub 16 means that the induced current in the down conductor 50 can arc across the interface and this phenomenon generates electromagnetic emissions that can cause interference with electronics in the vicinity of the wind turbine 10. Since industrial systems such as wind turbines 10 need to comply with established EMC standards, electromagnetic emissions at the LCTU 54 are undesirable.

To guard against this, the arrangement shown in FIG. 2 includes a conductive path or bridge 60 that extends between the down conductor 50 of the lightning protection system 31 and the earth line 44 of the anti-icing system 30. The conductive path 60 provides a low impedance path for parasitic current to be conducted from the down conductor 50 to the earth line 44 of the anti-icing system 30 at the typical frequency range at which the anti-icing system operates, i.e. below approx. 100 Hz.

To protect the anti-icing system 30 against overwhelmingly high currents that would occur at higher frequencies inherent in lightning strikes i.e. 10 kHz and above, the conductive path 60 includes a transient current limiting device 62. Advantageously, the transient current limiting device 62 has a relatively low impedance at a first electrical frequency associated with the anti-icing system 30, for example, below approximately 100 Hz, and a relatively high impedance at a second electrical frequency range that is associated with a lightning strike, for example from 10 kHz and above.

The impedance established by the transient current limiting device 62 at both frequency ranges is determined to block current through the conductive path 60 at relatively high frequencies, as defined here, but to permit current flow at relatively low frequencies. It is envisaged that a minimum ratio of impedance between the low and high frequency ranges mentioned above should be 1:100.

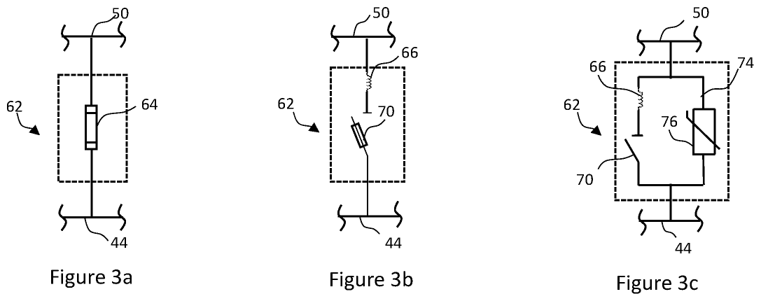

The transient current limiting device 62 may be configured in various ways. Some example configurations are illustrated in FIGS. 3a-3c.

Referring firstly to FIG. 3a, the transient current limiting device 62 is shown as being implemented by a resistive fuse element 64. The resistive fuse element 64 may be selected to have an appropriate resistance so as to go open circuit when current of a predetermined level flows through the down-conductor 50. Therefore, at a relative low frequency range of parasitic current, and correspondingly low current magnitude, the resistive fuse element 64 permits current to flow through the conductive path 60 to the earth line 44 of the anti-icing system 30 as it presents a low impedance path. Conversely, at a relatively high frequency, and a correspondingly high current associated with lightning strikes, the resistive fuse element 64 is configured to fuse thereby going open circuit thereby presenting a very high impedance to current.

An advantage of this solution is that it is cost effective to implement since it is elegantly simple in terms of electronic components. However, once the resistive fuse element 64 has blown, it will require replacement which limits its practicality as a solution, particularly for remote located wind turbines, such as most offshore wind turbines.

A second example is illustrated in FIG. 3b, in which the conductive path 60 includes an inductor 66. The conductive path 60 in this example also includes a protective switch 70. The protective switch 70 and the inductor 66 are connected in series in the conductive path 60. As will be appreciated from the Figure, the inductor 66 is coupled to the protective switch 70 on the high voltage side of the protective switch 70. That is to say the inductor 66 is connected between the conductive path 60 and the protective switch 70. The inductor 66 is in the conductive path 60 in this example in a position where it is on the side of the switch proximate the down conductor 50. Expressed another way, the inductor 66 is located on the high-voltage side of the switch 70.

The protective switch 70 is controlled by the anti-icing system 30 to be configured to a closed position when the anti-icing system 30 is in operation and to an open position when the anti-icing system 30 is not in operation. Beneficially, therefore, the conductive path 60 is only brought into operation when the anti-icing system 30 may generate parasitic currents in the down conductor 50. Despite there being only a small probability of lightning when icing conditions are present, decoupling the protective switch 70 in this way provides a further safety measure.

A simple on/off state depending on the operational state of the anti-icing system 30 is one example of operational logic that could be applied to the protective switch 70. Further logic may be used to enhance the operation of the protective switch 70. For example, in one enhancement of the functionality, suitable logic could be provided to configure the protective switch 70 into an open position where a lightning strike has been detected or is anticipated in the proximity of the wind turbine 10. A wind power plant comprising several such wind turbines 10 could, for example, provide detection functionality. If a lightning strike is detected in one of the wind turbines in the wind power plant, then the protective switch 70 may be opened wind turbines to protect the anti-ice system 30 and the inductor 66 which may be degraded during a lightning strike. In addition to lightning being detected, the protective switch 70 may be configured to open when lightning is anticipated or predicted, which may be achieved in various way for example based on atmospheric conditions. For example, a monitoring system may be configured to measure environmental factors such as pressure, temperature, liquid water content, and even weather forecast data, to evaluate lightning conditions.

The characteristics of the inductor 66 may be chosen suitably to provide the required functionality as stipulated above. Without wishing to be bound by theory, it is believed that inductor values between 50 μH and 1000 μH provide such a suitable range. In principle, a variable inductor could be used in order that the function of the transient current limiting device 62 may be adjusted.

A further example is shown in FIG. 3c. The form of transient current limiting device 70 shown in FIG. 3c is similar to that in FIG. 3b in that it comprises a conductive path 60 which comprises a protective switch 70 and an inductor 66. The discussion above relating to FIG. 3b is thus also relevant here.

However, the example of FIG. 3c has a second conductive path 74 in parallel with the first mentioned conductive path 60. The second conductive path 74 in this example includes a surge protection device 76. The surge protection device 76 provides a further conduction path through which current may travel from the anti-icing system 30 to the down conductor 50 of the lightning protection system 31 in the event of a lightning strike on components of the anti-icing system 30. Therefore, the surge protection device 74 provides a safety function.

By way of further explanation, consider the situation where the anti-icing system 30 is in operation such that the protective switch 70 is closed, and where ambient conditions are such that a lightning strike is possible. As described above, the protective panels 56 shield the respective underlying heating devices 32 from a lightning strike. However, in the unlikely event that lightning does attach to a heating device 32, the electronics of the anti-icing system 30 should desirably be protected from damage from lightning current, as should be other electronics of the wind turbine. In the FIG. 3c example, however, not only does the conductive path 60 provide a route for parasitic currents from the down conductor 50 to the earth line 44 of the anti-icing system 30, but the second conductive path 74 provides a route for lightning current to travel to the lightning protection system 31 via the surge protection device 76.

As the skilled person would understand, known surge protection devices 76 for industrial electronics are able to conduct and shunt current with a very fast response time, therefore protecting sensitive electronics. As the skilled person would know, the surge protection device 76 comprises suitably configured components such as a metal oxide varistor, resistors and capacitors in order to provide sufficient current handling during lightning strikes. It is within the ambit of the skilled person to configure operational parameters of surge protection devices 76, such as a voltage rating, a current rating and a response time to suit the application. Suitable surge protection devices76 are available from Raycap GmbH, for example under the ‘Strikesorb’80 range of devices, by way of non-limiting example.

The examples shown in FIGS. 3b and 3c are beneficial particularly for remotely located wind turbines since their operation will not be adversely affected by a lightning strike to the lightning protection system 31.

In the above discussion, various modifications and variants to the illustrated examples have been introduced. However, the skilled person would appreciate that that other changes could be made without departing from the inventive concept as defined by the claims.

1. A wind turbine blade comprising:
an anti-icing system comprising an electrothermal heating arrangement configured to provide heat to an external surface of the blade, wherein the electrothermal heating arrangement is connected to a power supply interface of the wind turbine blade by way of a power supply conductor and an earth conductor, a lightning protection system having a lightning strike protection device associated with an electrothermal heating element of the heating arrangement, the lightning strike protection device being connected to a lightning down conductor of the lightning protection system leading to a current transfer unit configured to transfer lightning current to a rotor hub, in use, and a transient current limiting device connected in a conductive path between the lightning down conductor of the lightning protection system and the earth conductor of the anti-icing system, thereby permitting induced parasitic currents in the lightning down conductor to earth through the anti-icing system (30).

2. The wind turbine blade of claim 1, wherein the lightning strike protection device is spaced from the electrothermal heating element so as to form a capacitive coupling.

3. The wind turbine blade of claims 1, wherein the transient current limiting device has a relatively low impedance value at a first electrical frequency range associated with the anti-icing system, and a relatively high impedance value at a second electrical frequency range associated with a lightning strike.

4. The wind turbine blade of claim 3, wherein the first electrical frequency range is less than 100 Hz.

5. The wind turbine blade of claim 3, wherein the second electrical frequency range is greater than 10 KHz.

6. The wind turbine blade of any one of claim 3, wherein the ratio between the relative low impedance value and the relatively high impedance value is at least 1:100.

7. The wind turbine blade of claim 1, wherein the transient current limiting device includes a resistive fuse element in the conductive path.

8. The wind turbine blade of any one of claim 6, wherein the transient current limiting device includes a switch device in the conductive path.

9. The wind turbine blade of claim 8, wherein the switch device is operable into a closed position when the anti-icing system is in operation.

10. The wind turbine blade of claim 9, wherein the switch device is operable into an open position when a lightning condition is detected and/or anticipated.

11. The wind turbine blade of claim 10, wherein the transient current limiting device includes an inductor in the conductive path

12. The wind turbine blade of any of claim 11, wherein the inductor is on the high voltage side of the switch device

13. The wind turbine blade of claim 12, wherein the transient current limiting device include a surge protection device (76) in parallel with the switch device

14. (canceled) Please add the following new claims:

15. A wind turbine, comprising:
a tower;
a nacelle disposed on the tower;
a rotor extending from the nacelle;
a rotor hub attached to a distal end of the rotor;
at least one wind turbine blade attached to the rotor hub; wherein at least one wind turbine blade comprises:
an anti-icing system comprising an electrothermal heating arrangement configured to provide heat to an external surface of the at least one wind turbine blade, wherein the electrothermal heating arrangement is connected to a power supply interface of the at least one wind turbine blade by way of a power supply conductor and an earth conductor;
a lightning protection system having a lightning strike protection device associated with an electrothermal heating element of the electrothermal heating arrangement, the lightning strike protection device being connected to a lightning down conductor of the lightning protection system leading to a current transfer unit configured to transfer lightning current to the rotor hub, in use; and
a transient current limiting device connected in a conductive path between the lightning down conductor of the lightning protection system and the earth conductor of the anti-icing system, thereby permitting induced parasitic currents in the lightning down conductor to earth through the anti-icing system.
